(19) United States
(12) Patent Application Publication
(10) Pub. No.: US 2022/0088845 A1
(43) Pub. Date: Mar. 24, 2022

(54) IMPROVEMENTS IN OR RELATING TO INJECTION SYSTEMS

(71) Applicant: COEXPAIR, Namur (BE)

(72) Inventors: André BERTIN, Vedrin (BE); Bertrand VANEGHEM, Dion-Valmont (BE)

(21) Appl. No.: 17/426,036

(22) PCT Filed: Jan. 29, 2019
(86) PCT No.: PCT/EP2019/052090

§ 371 Date: Jul. 27, 2021

(51) Int. Cl. B29C 45/76; B29C 45/84; B29C 45/26; B29C 45/03

(52) U.S. Cl. CPC B29C 45/7613; B29C 45/84; B29C 45/2669; B29C 45/03; B29C 2045/2671; B29C 2945/76658; B29C 2945/76167; B29C 2945/76381; B29C 2945/7618; B29C 2945/76545; B29C 2945/76859; B29C 2945/76163

(57) ABSTRACT

A resin detection system for closing an automated valve to prevent resin entering a vacuum line portion of an outlet line is described. The resin detection system comprises a support (300) to a pneumatically-actuated device (320), a capacitive sensor (380) and a valve (410) are mounted. The sensor is configured to provide at least one signal indicative of the presence of resin in the outlet line which is used to close the valve automatically once the presence of resin is sensed by the capacitive sensor. The resin detection system forms part of an injection moulding apparatus and receives signals from a processor thereof to ensure that, if too much resin is injected, the valve is automatically closed even in the event that the sensor does not detect the presence of resin in the outlet line.

### FIELD OF THE INVENTION

The present invention relates to improvements in or relating to injection systems, and is more particularly, although not exclusively concerned with thermoset resin injection moulding systems.

### BACKGROUND OF THE INVENTION

In resin transfer moulding (RTM) processes, a mould or tool includes one or more shaped mandrels are placed. Dry fabric is positioned over the mandrel(s) and the mould or tool is closed to define a cavity. A vacuum line, connected to a vacuum pump, is attached to the mould or tool to remove air from the cavity. Resin is supplied to the mould or tool through an injection line, and, flow of the resin within the mould or tool impregnates the dry fabric. Once the resin begins to flow out of the mould or tool through the vacuum line, a valve in the vacuum line is closed off.

In same qualified resin transfer moulding (SQRTM) moulding processes, a pre-form which has already been shaped and impregnated with resin prior to insertion in the mould or tool is used. Once the mould is closed, only a small additional quantity of resin needs to be injected around the part in order to exert the hydrostatic pressure necessary to consolidate the pre-form in the mould and eliminate any gas bubbles that may form during the setting of the resin. SQRTM is a closed moulding process that combines pre-form processing and liquid moulding to produce an autoclave-quality part without the need for an autoclave that is suitable for use in aerospace parts.

In both moulding processes, resin is injected into the mould or tool cavity either to impregnate dry fabric or a pre-form with the injected resin (RTM) or to apply pressure to the component in the cavity due to the injected resin (SQRTM), during the moulding process, and, to avoid wasting resin as it flows out of the mould or tool, the shut-off of the valve is manually-controlled by an operator standing by the mould or tool.

Whilst systems exist which detect resin flow in the outlet tube and stop the flow using optical detection through a transparent outlet tube, the flow is stopped by pinching the outlet tube or by using a commercial automatic valve; however, these systems tend to be unreliable from the point of view of detection of the resin and shutting off the resin flow in response to such detection. Pinching the outlet tube requires that the tube needs to be soft and stopping the resin flow is not always ensured and leakages are possible. Commercial valves tend not to be able to accommodate high vacuum with low leakage, high pressure, and high temperature. In addition, as the resin will polymerise within the valve, none of the commercial valves are configured such that at least the part of the valve in contact with the resin can easily be replaceable at low cost and low set-up time.

### SUMMARY OF THE INVENTION

It is therefore an object of the present invention to provide injection moulding apparatus including a resin detection system for automatic detection of resin flow and valve closure as a result of such detection of resin flow.

In accordance with one aspect of the present invention, there is provided an injection moulding apparatus as defined in claim 1.

By automatically sensing the presence of resin in the outlet line and closing the valve at a position downstream of the at least one sensor, resin flow can be terminated prior to contaminating the remainder of the outlet line. The outlet line may comprise a vacuum line, and, it is desirable not to contaminate the vacuum line or a vacuum pump to which the vacuum line is attached.

In an embodiment, the sensor may be positioned either upstream or downstream of the valve.

In an embodiment, the processor may further be configured for determining an actual quantity of liquid resin injected into the inlet line, for comparing the determined quantity of liquid resin with the prescribed quantity of liquid resin, and for generating a signal when the comparison exceeds a predetermined threshold to close the valve in the outlet line.

This has the advantage that, in the case that resin detection in the outlet line fails, it is possible to ensure that the valve can be closed to prevent contamination of the vacuum pump and associated portion of the outlet line downstream of the valve. In addition, the quantity of resin which may be wasted is minimised.

In an embodiment, the resin detection system may comprise a differential detector having first and second sensors and the at least one signal comprises a differential signal derived from signals provided by the first and second sensors.

This ensures that any “out of range” values do not trigger the closure of the valve unnecessarily and that the reliability of detection of the presence of resin in the outlet line is up to 9999 in 10000.

If more than one sensor is used, a comparison of the two signals may be used to provide the signal the actuator device after processing by the processor.

In an embodiment, the at least one sensor comprises a capacitive sensor.

By using one or more capacitive sensors, it is possible to determine the presence of resin within the outlet resin line when the outlet resin line is not fully transparent. However, a transparent line also allows for a visual determination of the presence of resin in the outlet resin line.

In an embodiment, the resin detection system may further comprise an actuator device configured for receiving the at least one signal to close the valve.

By having a separate actuator device for the valve, the actuator device can form a permanent part of the injection moulding apparatus and the valve can be replaceable at low cost.

In an embodiment, the resin detection system may further comprise location means for locating the valve in a predetermined position with respect to the at least one sensor and the actuator device.

The locating means provides accurate and permanent positioning for the sensor and the actuator device as well as providing accurate positioning for the valve which can readily and easily be replaced after each injection moulding cycle.

In an embodiment, the location means may comprise a support configured for mounting the valve, the actuator device and the at least one sensor in their respective predetermined positions.

This provides a permanent arrangement for the actuator device and the at least one sensor whilst allowing the valve to be readily replaced and located in a position which is accurate with respect to the actuator device.

The support may further comprise at least one clamp configured for removably mounting the valve to the actuator device.

In this way, the at least one clamp retains the valve in the correct position once it is correctly located with respect to the actuator device whilst also allowing it to be readily replaced after each injection moulding cycle.

In an embodiment, the actuator device comprises a pneumatically-actuated device configured for activating the valve in response to the at least one signal.

By having a pneumatically-actuated device, there is no issue with environmental conditions in the vicinity of the device affecting the operation thereof.

In an embodiment, the valve comprises a high vacuum, high pressure, high temperature valve. In one embodiment, the valve comprises a modified ball valve. A ball valve has been shown to meet the requirements of being able to operate under high vacuum, high pressure and high temperature conditions.

In an embodiment, the outlet line is configured to be spaced from the at least one sensor by a distance which is less than the diameter of the outlet line.

Such a spacing optimises the detection of the liquid resin in the outlet line

In accordance with another aspect of the present invention, there is provided a method of operating injection moulding apparatus as defined in claim 15.

This method has the advantage that the system can be thoroughly tested before injection.

Step a) may further comprise replacing the valve if the vacuum leak test indicates a vacuum level which is not in accordance with a predetermined threshold and repeating the vacuum leak test for a replacement valve.

In this way, the reliability of the valve is increased as the probability that a valve would fail during injection is substantially reduced.

In an embodiment, step d) may comprise generating an alarm when the valve in the outlet line is closed. Such an alarm may be used to notify an operator that the injection moulding cycle has been completed.

In an embodiment, step b) may comprise detecting an actual quantity of liquid resin injected into the inlet line, comparing the determined quantity with the prescribed quantity, and generating a signal when the comparison exceeds a predetermined threshold to close the valve in the outlet line.

In this way, even if the valve fails during injecting of the liquid resin into the mould, by determining if too much liquid resin has been injected, it is possible to send a signal to the injector to stop further injection of liquid resin.

As described above, an alarm may be generated when the predetermined threshold has been exceeded.

In an embodiment, steps a) to d) may be performed automatically.

This has the advantage that no operator intervention is required unless the valve is found to be faulty when performing the vacuum leak test.

### BRIEF DESCRIPTION OF THE DRAWINGS

For a better understanding of the present invention, reference will now be made, by way of example, to the accompanying drawings in which:—

FIG. 1 illustrates a schematic block diagram of a resin transfer moulding (RTM) injection system in accordance with the present invention;

FIG. 2 illustrates a typical RTM injection sequence;

FIG. 3 illustrates a perspective top view of a resin detection system located in an outlet line of the injection system of FIG. 1;

FIG. 4 illustrates a perspective view of the resin detection system with an outlet line assembly prior to insertion therein; and

FIG. 5 is similar to FIG. 3 but illustrating the outlet line assembly mounted within the resin detection system.

### DESCRIPTION OF THE INVENTION

The present invention will be described with respect to particular embodiments and with reference to certain drawings but the invention is not limited thereto. The drawings described are only schematic and are non-limiting. In the drawings, the size of some of the elements may be exaggerated and not drawn on scale for illustrative purposes.

Although the present invention will be described with reference to resin transfer moulding (RTM) processes, it will readily be appreciated that the invention is also applicable to same qualified resin transfer moulding (SQRTM) processes and to other moulding processes where a vacuum is used to draw liquid resin through a mould.

The resin detection system of the present invention is based on a modified manually-operated ball valve which is traditionally supplied with an operating lever. Such a valve meets the requirements high vacuum and high liquid pressure and has been shown to have a reliability which at least, if not better than, 999 in 1000. Even with a 1 in 1000 chance of failure, it is normally tested during a vacuum leak test prior to injection of the resin. If the valve fails during this test, it can be replaced before injection thereby reducing the probability that the valve will fail during the injection process to almost zero.

Moreover, even if the valve passes the vacuum leak test, it may still fail during injection, and, the injection moulding apparatus of the present invention is configured to detect the injection of an excessive quantity of resin and will force the valve to close triggering an alarm.

However, for automation, the lever on the valve is removed and the gland of the ball valve is blocked with an actuator interface or actuator portion. The actuator portion of the valve is operated by the pneumatically-actuated control device by way of the ball valve interface under control of a processor or controller on detection of the presence of resin in the outlet line. By having an actuation system which is pneumatic, it is possible to operate such a valve in a 180° C. environment. This high temperature resistance enables the location of the resin detection system to be very close to the outlet from the mould or tool so that the quantity of lost resin is minimised, that is, excess resin not used in the injection moulding cycle and left in the outlet line.

One or more capacitive sensors is installed along an outlet line connecting the outlet from the mould with a vacuum pump for resin detection. Capacitive sensors can operate at temperatures up to 180° C., and, need to be positioned close to the outlet line. Ideally, the outlet line comprises tube which is typically spaced at a distance less than the diameter of the tube, from the sensor(s). The distance between the sensor(s) and the outlet line can therefore be considered to be similar at each installation with less than 1 mm variation.

The sensor(s) are fixed on a support near to the outlet from the mould. The support also provides a fixed location on which the valve in the outlet line is removably mounted thereon. The replacement of the actuator or of the sensor is easy in case maintenance is required. The support is resistant to temperatures up to 180° C. so it can be located next to the mould or tool.

In an embodiment, the support features a groove or channel to locate the outlet line upstream of the sensor(s). The valve mounted in the outlet line between the mould and the vacuum pump is then easily located under a toggle clamp and fixed to the support. The toggle clamp is used to maintain the valve in position as well as the outlet line with respect to the support and sensor(s).

Resin flow from the outlet is in one direction and the system reaction time of the injection moulding apparatus is fast enough so that the valve can be closed before the resin can leave the valve and pass further down the outlet line towards the vacuum pump.

Capacitive sensor operation is better if a plastic tube is used for the outlet line. In case a metallic tube is required to sustain the pressure after valve is closed, the outlet line may be metallic upstream of the valve, that is, on the side of the valve connected to the outlet from the mould or tool. If the tube between the mould and the valve is metallic because it needs to withstand pressure in the tube once the valve is closed, the sensors may be installed in a plastic tube portion of the outlet line downstream of the valve which will never experience the high pressure. As the resin sets or gels as it cools, any parts touched by the resin needs to be disposable. The length of plastic tube through which the resin flows can be very limited if it is oriented correctly to avoid further flow under gravity.

When the resin appears, one or more signal from the sensor(s) is transmitted to a processor for processing. The processor provides a control signal to the pneumatically-actuated device to close the ball valve in response to signal(s) received from the sensor(s).

In the most basic configuration, only one sensor is used and the signal triggers a relay which closes the valve. The reliability of this basic configuration may be limited.

In a more advanced configuration, a second sensor may be placed next to the first sensor, and, the processor is configured to receive signals from both sensors when resin is detected in the outlet line and to generate a differential signal based on the signals from both sensors for controlling the closure of the valve. As there is small time delay between the signals received from the two sensors, this improves significantly the reliability of detection of the presence of the resin in the outlet line up to 9999 in 10000.

The benefit of using a processor for detecting the signals from the sensors is that any “out of range” values can be detected and an alarm may be triggered for an operator to check that the outlet line is correctly installed with respect to the sensors or to determine if one of the sensors has failed, thereby allowing the operator can take appropriate remedial action.

If processor receives vacuum measurements in the outlet line at a point the vacuum level is influenced by the valve position, test sequences can be run to check that the valve closes and opens correctly. However, for this particular use of the valve, it is only verification that the valve closure is reliable and necessary. Measuring accurately the vacuum level variation with respect to time can also be used to detect that the valve closes firmly and is vacuum high. This measurement of vacuum level also indicates that the valve will not leak any fluid.

If the processor also receives information relating to the actual quantity of resin injected into the inlet line and into the mould or tool as well as the quantity prescribed by the processor, a comparison can be made between the two values, and if the comparison exceeds a predetermined threshold, a signal can be sent to the close the valve. When the predetermined threshold is exceeded, this can be due to a malfunction of the valve, a leakage in the mould or tool, and/or connecting tubes or pipes of the injection moulding apparatus. In such case, the processor can send a signal to close the valve and to trigger an alarm. An order to stop the injection can also be sent to the injector.

The detection of resin at exit of the mould or tool can be used to optimise the injection moulding cycle parameters. As example, the resin flow rate can be varied before and after valve closure.

The term “high temperature” as used herein refers to temperatures around the injection moulding temperature, for example, around 180° C.

The term “high pressure” as used herein refers to pressures up to 15 bar (1.5 MPa), preferably between 7 and 15 bar (between 0.7 and 1.5 MPa).

However, high pressure is not essential for the operation of the automated system of the present invention.

The term “high vacuum” as used herein refers to pressures less than 1.3 mbar (0.13 kPa).

The term “minimum leak rate” as used herein refers to a leakage rate of less than 1 mbar/min (0.1 kPa/min).

The term “reliability” as used herein is defined as the probability of success, that is, 1—probability of failure. For example, reliability values as used herein include 1 failure in 1000, 1 failure in 10000, 1 failure in 10 million etc.

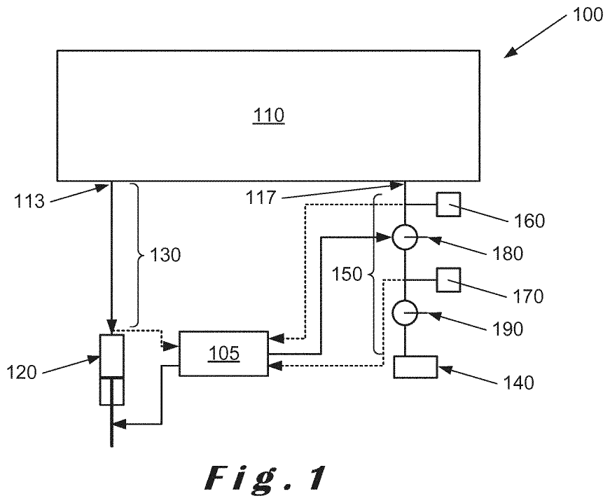

FIG. 1 illustrates a schematic block diagram of an RTM injection system 100 in which a mould or tool 110 is connected to an injection cylinder 120 by a resin inlet line 130, the resin inlet line being connected to the mould or tool 110 at an inlet 113 thereof. The mould or tool 110 is connected at an outlet thereof 117 to a vacuum pump 140 by an outlet line 150. A pressure transducer 160 and a vacuum transducer 170 are connected to the outlet line 150 to sense the pressure in the outlet line 150 between the outlet 117 from the mould or tool 110 and a first valve 180 and the vacuum in the outlet line 150 respectively. A second valve 190 is provided between the vacuum transducer 170 and the vacuum pump 140. The first valve 180 forms an exit valve which is closed as soon as resin flow is detected in the outlet line 150. In accordance with the present invention, the first valve 180 is automated as will be described in more detail below.

The injection moulding system 100 also includes a processor 105 which is connected to supply control signals:—

for the injection cylinder 120 to dispense resin into the inlet line 130 and into the mould or tool 110 at its inlet 113 (by accurately controlling the movement of a piston within the injection cylinder to have a predictable flow rate);

for the vacuum pump 140 to apply a vacuum to the mould or tool 110 through the outlet line 150; and

for the first and second valves 180, 190 to control the operation thereof.

In addition, the controller 105 also receives signals:

from the injection cylinder 120 indicating the actual quantity of resin dispensed for comparison with the prescribed quantity of resin that the injection cylinder was controlled to dispense;

from the pressure transducer 160 and from the vacuum transducer 170 indicating the measured pressure and the measured vacuum respectively, the measure pressure indicating the pressure applied to the mould or tool 110 by the injected resin and the measured vacuum indicating the vacuum applied by the vacuum pump—there is no need for other vacuum sensors as closing/opening of the valve is detectable using the vacuum transducer sensor 170; and

from one or more sensors (not shown) present in the outlet line between the mould or tool outlet 117 and the first valve 180 as will be described in more detail below.

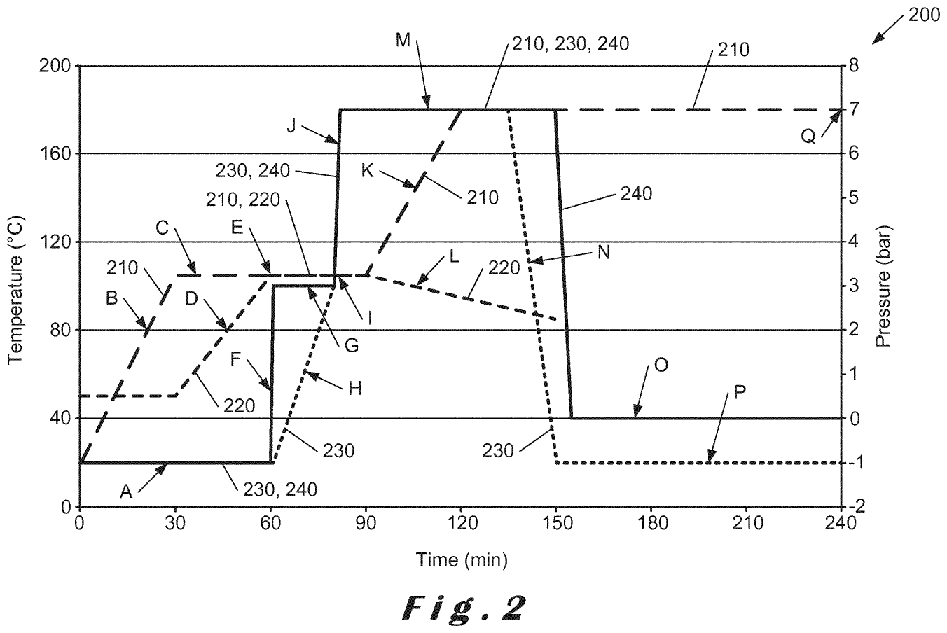

FIG. 2 illustrates a typical RTM injection sequence with respect to time 200. Long dashed line 210 illustrates the mould or tool temperature; medium dashed line 220 illustrates the injector cylinder temperature; short dashed line 230 illustrates the mould or tool pressure; and the solid line 240 illustrated the injection cylinder pressure. It will be understood that the lines overlap and merge, and, where that is the case, the relevant reference numbers are shown at those places. In addition, the process will be described by reference to letters as follows:

At A: the mould or tool and injection cylinder are under vacuum;

At B: the mould or tool is set to injection temperature ramping up the temperature to injection temperature at C;

At C: the injection temperature is attained by the mould or tool;

At D: the injection cylinder is set to injection temperature ramping up the temperature to injection temperature at E;

At E: the injection temperature is attained by the injection cylinder and matches the injection temperature of the mould or tool;

At F: resin is injected at a flow rate of 500 cm³/min at a pressure of 3 bar (300 kPa) until the hydrostatic state is reached at G;

At G: the pressure is maintained until injection has been completed;

At H: the tool pressure increases due to the injected resin until the hydrostatic state has been reached at I;

At I: the hydrostatic state is attained;

At J: the pressure in the mould or tool and the injection cylinder is increased to 7 bar (700 kPa) once injection has been completed;

At K: the temperature of the mould or tool is ramped up to cure temperature;

At L: the injection cylinder temperature drops after injection is complete;

At M: the injection cylinder pressure is maintained until the tool pressure drops;

At N: the mould or tool pressure drops due to resin gelling;

At O: the injection cylinder is shut down;

At P: the mould or tool pressure is under vacuum during the curing of the resin; and

At Q: the cure is completed and the component is removed from the mould or tool.

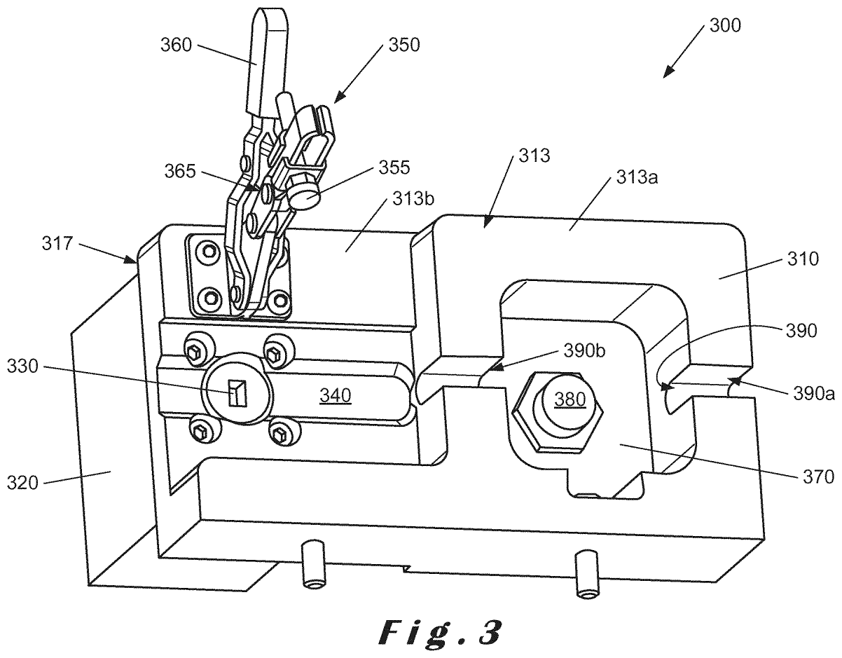

Turning now to FIG. 3, a support 300 for a resin detection system forming part of an injection moulding apparatus in accordance with the present invention is shown. The support 300 provides an accurate location for a valve and sensor(s) located upstream thereof. The relative positioning of the sensor(s) and the valve in the outlet line (not shown) enables detection of the liquid resin flow into the outlet line prior to the valve so that at least one signal can be transmitted either directly to the valve or close it as described in more detail below or to the processor. Once it has been determined that the liquid resin has been detected, a signal is sent to close automatically the first valve 180 in accordance with such detection. The resin detection system may be controlled by a processor (not shown), such as, a programmable logic controller (PLC).

In an embodiment (not shown), two sensors are arrange with respect to the outlet line to detect the presence of liquid resin therein. Each sensor provides a signals for the processor so that a differential signal can be determined, and, if that differential signal is above a predetermined threshold, a signal sis sent to close the valve.

The injection moulding apparatus having a resin detection system in accordance with the present invention has the following features:

a) a valve designed to satisfy the following requirements:
high vacuum up to 0.5 mbar (0.05 kPa) or above;
minimum leak rate of less than 0.1 mbar/min (0.01 kPa/min), preferably less than 1 mbar/min (0.1 kPa/min);
high pressure up to 15 bar (1.5 MPa), preferably in the range of between 7 and 15 bar (0.7 and 1.5 MPa) although this is not essential;
high temperature up to 180° C.;
polymerisation of the resin inside the valve;
part of the valve in contact with the resin is disposable with low cost and low set-up time; and
the reliability of the valve is better than 1 failure in every 1000 occurrences.

b) a resin detection system having the following requirements:
reliability better than 1 failure in every 10000 usages;
no calibration needed prior to usage; and
impervious to industrial environment perturbation, such as, changes in temperature, light, humidity, atmospheric pressure, dust, radio signals (Wi-Fi, currents, etc.).

c) injection system having the following requirements:
ability to inject a quantity of resin with a precision of ±5 cm³; and
reliability better than 1 failure in every 100000 usages.

d) processor having the following requirements:
reliability better than 1 in 10 million usages;
ability to control the valve either directly or indirectly via a separate actuator device (as described in more detail below); and
ability to control the injection moulding apparatus.

e) resin consumption—minimises resin waste in the outlet line

f) consumables—the length of pipe or tube between the outlet of the mould and the valve which fills with liquid resin, which then sets, is minimised and can be made of a plastics material (e.g. polytetrafluoroethylene (PTFE)) or in metal (e.g. copper, aluminium); in an embodiment, the outlet line comprises a mix of plastic and metal with the length of metallic pipe or tubing needed being optimised.

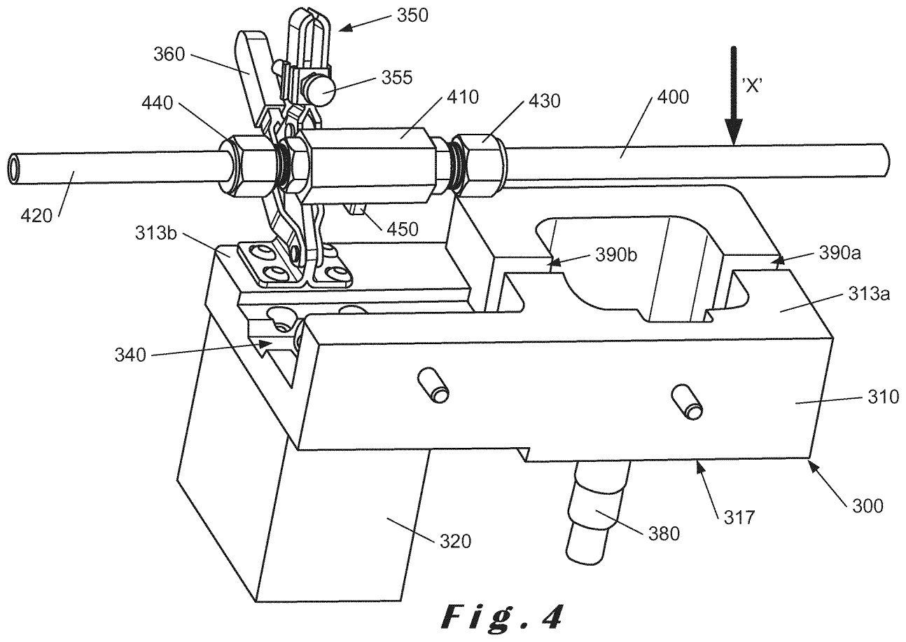

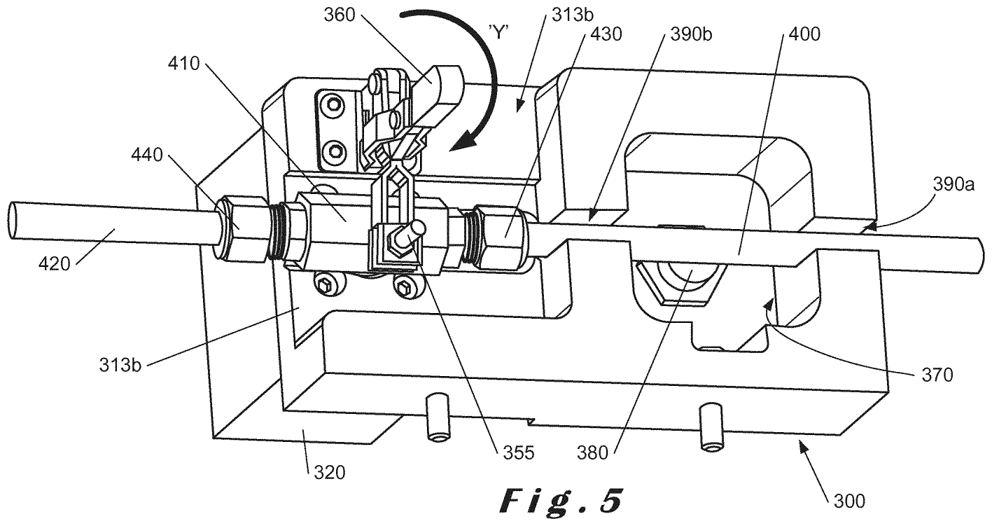

The support 300, as shown in FIG. 3, comprises a first portion 310 having a first surface 313 and a second surface 317. The first surface 313 comprises a raised portion 313a and a depressed portion 313b. A pneumatically-actuated device 320 is mounted to the second surface 317 of the first portion 310. The depressed portion 313b of the first surface 313 has an aperture 330 formed in an elongate recess 340, the aperture 330 forming an interface for the pneumatically-actuated device 320 and an actuator portion of a valve in the outlet line (not shown) with the recess 340 being configured to receive a valve mounted in the outlet line (not shown) as will be described in more detail below with reference to FIGS. 4 and 5. However, other configurations of the support 300 are also possible provided the positional relationships between the actuator device 320, the valve and the outlet line are maintained as described in more detail below.

A toggle clamp 350 is mounted to the depressed portion 313b of the first surface 313 adjacent the elongate recess 340 and the interface 330. The toggle clamp 350 includes a pressure-applying portion 355 and a handle portion 360 connected by means of a linkage mechanism 365 to the pressure-applying portion 355. The handle portion 360 is moveable between a first position where the pressure-applying portion 355 is not in contact with the valve (as shown in FIG. 4) and a second position where the pressure-applying portion 355 engages with a surface of the valve of the outlet line (FIG. 5) to hold the valve in position within the elongate recess 340 as will be described in more detail below.

The toggle clamp 350 is configured to hold the valve (not shown) in position within the elongate recess 340 with the valve aligned with the interface formed by aperture 330 for the pneumatically-activated device 320 when the handle is in the second position as described below with reference to FIGS. 4 and 5.

Although a toggle clamp has been described, it will be appreciated that other clamp arrangements may be used to ensure that the valve is held in the elongate recess 340 and in engagement with the interface 330.

A further recess 370 is formed in the raised portion 313a of the first surface 313 and a capacitive sensor 380 is mounted therein. The capacitive sensor 380 is configured to detect the flow of resin within the outlet tube prior to it reaching the valve as described in more detail below with reference to FIGS. 4 and 5.

As described above, two capacitive sensors may be provided which provide two signals for the processor in response to sensing the presence of resin in the outlet line, the processor performing a differential on the two signals and generating a differential signal which may be used to activate the pneumatically-actuated device 320 to close the valve.

As an alternative to using one or more capacitive sensors, one or more optical sensors may be used. In this case, the outlet line needs to be substantially transparent so that the change in appearance thereof can be detected when resin flows therethrough.

The processor may be configured to form part of a control system for the injection moulding apparatus. In this way, the timing of signals from the at least one sensor can be determined from the end of the injection moulding cycle.

A channel 390 is also formed in the raised portion 313a of the first surface 313 and is configured to retain the outlet line in position relative to the capacitive sensor 380 so that resin flow in the outlet line can be detected by the capacitive sensor and a signal generated thereby is used, either directly or via the processor, to operate the pneumatically-operated device 320. The channel 390 has a first portion 390a and a second portion 390b located on either side of the recess 370 as shown.

In FIGS. 4 and 5, components previously described with reference to FIG. 3 have the same reference numerals. FIG. 4 illustrates the support 300 prior to the introduction of the outlet line to which the valve is connected, and, FIG. 5 illustrates the support 300 with the outlet line connected to the valve and positioned and clamped on the support.

Whilst the term “outlet line” has been used, it will readily be appreciated that this may refer to a single tube or pipe which is connected to the outlet of the mould or tool, or it may refer to one or more tubes or pipes which form the outlet line. In the embodiments illustrated in FIGS. 4 and 5, the outlet line comprises an outlet line portion connecting the valve to the outlet from the mould or tool, and, a vacuum line portion connecting the valve to the vacuum pump. The outlet line portion and the vacuum line portion may comprise the same material or different materials, for example, a substantially transparent plastic material may be used for the outlet line portion so that the sensor can easily detect the resin flow therein, and, a metallic tube may be used for the vacuum line portion to be able to withstand the vacuum applied by the vacuum pump.

The outlet portion is disposable together with the valve connected thereto. Ideally, the support is as close to the outlet of the mould as possible with the length of the outlet portion being minimised to reduce the amount of tubing which is discarded after each injection moulding cycle.

Disconnection of the valve at the vacuum line portion means that the vacuum line portion can be re-used. This is particularly advantageous if the vacuum line portion is chosen to withstand the high vacuum created by the vacuum pump.

FIG. 4 illustrates the support 300 with the toggle clamp 350 fixed to the base portion or plate 310 prior to the reception of an outlet tube portion 400, valve 410 and a vacuum tube portion 420. The outlet line portion 400 and the vacuum line portion 420 are connected to the valve 410 by means of respective connectors 430, 440.

As shown, the valve 410 has an actuator portion 450 which is configured to engage with the interface 330 so that the actuator portion 450 can be moved from a first position where the valve is open and a closed position where the valve is closed by the operation of the pneumatically-actuated device 320.

The valve 410 is placed into the recess 340 with the actuator portion 450 in the interface 330 and with the outlet line portion 400 in the channel 390, as shown by arrow ‘X’. As the channel 390 is formed over the recess 370, the outlet line portion 400 is supported by channel portions 390a, 390b so that the outlet tube portion is at a predetermined distance from the capacitive sensor 380. Typically, the outlet line portion 400 is at a maximum distance from the sensor which is equivalent to the diameter of the outlet line portion 400. Naturally, the actual distance may depend on the diameter of the outlet line portion 400 and its transparency.

As described above, the valve 410 may comprise a modified ball valve arrangement. However, other suitable valves may be used.

The toggle clamp 350 is operated so that the handle 360 is moved from its first position to its second position as shown by arrow ‘Y’ in FIG. 5. In this position, the valve 410 is clamped in place with respect to the recess 340 with the actuator portion 450 thereof engaged within the interface 330.

Flow of resin in the outlet line portion 400 is detected by the capacitive sensor 380 and the signal indicative of the presence of resin in the outlet line portion 400 may be sent directly to the pneumatically-actuated device 320 or via the processor to deploy the actuator portion 450 to close the valve 410 and prevent the flow of resin through the valve 410 and into the vacuum line portion 430.

Once an injection cycle has been completed by the injection moulding apparatus, the handle 360 of the toggle claim 350 is moved to its first position (in a direction opposite to that shown by arrow ‘Y’ in FIG. 5) and the outlet line portion 400 and the valve 410 are removed from the first portion 310, and, disconnected from the vacuum line portion 430 and from the mould and discarded together with any remaining resin in the outlet line portion 400 and valve 410. The mould or tool is cleaned ready for the next operation, and, a new outlet line portion and valve is connected to the outlet from the mould or tool and to the vacuum line portion ready for the next operation.

In preparation for the next injection cycle, a new outlet line portion is connected to a new valve and to the outlet of the mould or tool. The other end of the new valve is connected to the vacuum pump by way of the same vacuum line portion as it has not been contaminated with resin in the previous operation.

Although the support is described as having a depressed surface portion and a raised surface portion, it will be appreciated that other configurations may be possible which provide the correct alignment for the valve and the outlet line portion with respect to the pneumatically-actuated device and the sensor (or sensors if more than one sensor is present) respectively.

Although the sensor is described as being positioned upstream of the valve, it may also be positioned downstream of the valve and be associated with a plastic tube portion provided in the outlet line downstream of the valve. This may be the case where high pressure needs to be maintained between the valve and the mould and a metallic tube portion is used in the outlet line between the mould and the valve.

The resin detection system described above, namely, the valve, the actuator device, and the sensor(s) form part of an injection moulding apparatus, for example, RTM or SQRTM systems where a vacuum is applied to the mould during the injection cycle. Whilst the resin detection system can be used independently of the processor for the injection moulding apparatus, in an embodiment, the processor of the injection moulding apparatus may used to control the resin detection system so that an integrated system is provided.

Operating injection moulding apparatus using the resin detection system requires that the valve can be replaced before injection if it is found to be faulty during a vacuum leak test. Even if the valve is not found to be faulty, it may still jam or malfunction during injection. In this case, the quantity of liquid resin injected is monitored by the processor or controller, and, compared to the prescribed quantity, and, if the quantity of liquid resin injected is greater than the quantity prescribed for injection and exceeds a predetermined threshold, the processor is configured to operate the actuator device to close the valve. By monitoring the quantity of liquid resin injected, it is also possible to compensate for malfunction of the sensor(s) with the same result, that is, the actuator device is triggered to close the valve preventing the flow of liquid resin to the vacuum pump. In both cases, that is, malfunction of the valve or the sensor, alarms can be initiated by the processor so that operators in the vicinity of the injection moulding apparatus can be alerted to the malfunction(s).

Although a specific embodiment of the resin detection system has been described, it will be appreciated that other embodiments thereof may be implemented subject to meeting the requirements of temperature, pressure and vacuum.

1. An injection moulding apparatus comprising:
a mould having an inlet and an outlet;
an inlet line connectable to the inlet of the mould;
an outlet line connectable to the outlet of the mould;
an injector connectable to the inlet line and configured for injecting liquid resin into the mould through the inlet line; and
a processor configured for controlling the injector for at least one injection moulding cycle to inject a prescribed quantity of liquid resin into the inlet line;
characterised in that the injection moulding apparatus further comprises a resin detection system located in the outlet line and configured for detecting the presence of liquid resin in the outlet line and for providing at least one signal indicative of the detected liquid resin in the outlet line, the resin detector system comprising an automated valve and at least one sensor located in a predetermined position with respect to the valve, the at least one signal being used for closing the valve.

2. An injection moulding apparatus according to claim 1, wherein the predetermined position comprises one of: upstream of the valve and downstream of the valve.

3. An injection moulding apparatus according to claim 1, wherein the processor is further configured for determining an actual quantity of liquid resin injected into the inlet line, for comparing the determined quantity of liquid resin with the prescribed quantity of liquid resin, and for generating a signal when the comparison exceeds a predetermined threshold to close the valve in the outlet line.

4. An injection moulding apparatus according to claim 3, wherein the generated signal is configured for generating an alarm.

5. An injection moulding apparatus according to claim 1, wherein the resin detection system comprises a differential detector having first and second sensors and the at least one signal comprises a differential signal derived from signals provided by the first and second sensors.

6. An injection moulding apparatus according to claim 1, wherein the at least one sensor comprises a capacitive sensor.

7. An injection moulding apparatus according to claim 1, wherein the resin detection system further comprises an actuator device configured for receiving the at least one signal to close the valve.

8. An injection moulding apparatus according to claim 7, wherein the resin detection system further comprises location means for locating the valve in a predetermined position with respect to the at least one sensor and the actuator device.

9. An injection moulding apparatus according to claim 8, wherein the location means comprises a support configured for mounting the valve, the actuator device and the at least one sensor in their respective predetermined positions.

10. An injection moulding apparatus according to claim 9, wherein the support further comprises at least one clamp configured for removably mounting the valve to the actuator device.

11. An injection moulding apparatus according to claim 7, wherein the actuator device comprises a pneumatically-actuated device configured for activating the valve in response to the at least one signal.

12. An injection moulding apparatus according to claim 1, wherein the valve comprises a high vacuum, high pressure, high temperature valve.

13. An injection moulding apparatus according to claim 12, wherein the valve comprises a modified ball valve.

14. An injection moulding apparatus according to claim 1, wherein the outlet line is configured to be spaced from the at least one sensor by a distance which is less than the diameter of the outlet line.

15. A method of operating injection moulding apparatus including a mould having an inlet and an outlet, an inlet line connectable to the inlet of the mould, and outlet connectable to the outlet of the mould, an injector connectable to the inlet line and configured for injecting liquid resin into the mould through the inlet line, a processor configured for controlling the injector for at least one injection moulding cycle to inject a prescribed amount of liquid resin into the inlet line, and a resin detection system located in the outlet line and configured for detecting the presence of liquid resin in the outlet line and for providing at least one signal indicative of the detected liquid resin in the outlet line, the resin detector system comprising a valve and at least one sensor located in a predetermined position with respect to the valve, the at least one signal being used for closing the valve, the method comprising the steps of:
a) performing a vacuum leak test on the apparatus prior to injecting liquid resin;
b) if conditions for the vacuum leak test are met, injecting a prescribed quantity of liquid resin into the mould;
c) detecting the presence of liquid resin in the outlet line; and
d) operating the valve in the outlet line to terminate flow of resin therethrough in response to the detection of the presence of liquid resin in the outlet line.

16. A method according to claim 15, wherein step d) further comprises generating an alarm.

17. A method according to claim 15, wherein step a) comprises replacing the valve if the vacuum leak test indicates a vacuum level which is not in accordance with a predetermined threshold and repeating the vacuum leak test for a replacement valve.

18. A method according to claim 15, wherein step b) comprises determining an actual quantity of liquid resin injected into the inlet line, comparing the determined quantity with the prescribed quantity, and generating a signal when the comparison exceeds a predetermined threshold to close the valve in the outlet line.

19. A method according to claim 18, wherein step d) further comprises generating an alarm when the predetermined threshold is exceeded.

20. A method according to claim 15, further comprising performing steps a) to d) automatically.
